(19) United States
(12) Patent Application Publication
(10) Pub. No.: US 2026/0040025 A1
(43) Pub. Date: Feb. 5, 2026

(54) Systems, Methods, and Apparatuses for Resource Management

(71) Applicant: Parking Pin, LLC, Austin, TX (US)

(72) Inventors: Robert Wilson, Austin, TX (US); Troy Blaylock, Tustin, CA (US); Bernard Allotey, Athens, AL (US); Salwa Jeries, Huntsville, AL (US); Troy Tillery, Charlotte, NC (US)

(21) Appl. No.: 18/789,819

(22) Filed: Jul. 31, 2024

(51) Int. Cl. H04W 4/021; G08G 1/14

(52) U.S. Cl. CPC H04W 4/021; G08G 1/14

(57) ABSTRACT

Techniques for managing availability of a geofenced resource are described. A stored metric indicating the availability of a resource of a geofenced resource area is updated in response to a geofence event. An indication of the availability of the resource based on the stored metric is provided in response to receiving a request for resource availability information associated with the geofenced resource area.

### BACKGROUND

There are many different types of space-limited, or otherwise-limited, resources or resource areas that are used regularly by many people. Examples include parking areas, shared work areas, picnic areas, parks, various event venues, library resources, compute resources, etc.

### BRIEF DESCRIPTION OF DRAWINGS

Various examples in accordance with the present disclosure will be described with reference to the drawings, in which:

FIG. 1 illustrates examples of a geofenced resource area.

FIG. 2 illustrates examples of a parking user application interface screen.

FIG. 3 illustrates examples of a parking user application interface screen.

FIG. 4 illustrates examples of an administrator interface screen.

FIG. 5 illustrates examples of an administrator interface screen.

FIG. 6 illustrates examples of an administrator interface screen.

FIG. 7 illustrates examples of a system for indicating availability of and managing a geofenced resource area.

FIG. 8 illustrates examples of a system for indicating availability of and managing a geofenced resource area.

FIG. 9 illustrates examples of user data.

FIG. 10 illustrates examples of a flow for indicating availability of and managing a geofenced resource area.

FIG. 11 is a flow diagram illustrating operations of a method for indicating availability of and managing a geofenced resource according to some examples.

FIG. 12 illustrates a logical arrangement of a set of general components of an example computing device.

### DETAILED DESCRIPTION

The present disclosure relates to methods, apparatus, systems, and non-transitory computer-readable storage media for indicating availability of and managing a geofenced resource area.

Driving around looking for available parking, having to park far away from a desired destination, or arriving at a work area, picnic area, event venue, etc. and then finding it full, for example, can waste valuable time, increase congestion and cause frustration.

Planning time to get from one place to another can not only include travel time, but also an estimate of how long it may take to find a particular resource or where to go for that resource closest to the desired destination. For example, if a college student is trying to determine when to leave for a class, they may need to consider typical travel time and the time it may take to find parking on campus, which may vary based on the time of day, day of the week, the month of the year, if the day is a holiday, etc. If available parking is far from the class, they may also need to take into account additional time to travel from their parking space to the classroom.

Using the example of a parking area on a college campus for purposes of illustration, to make it to class on time, a college student not only needs to estimate their travel time, but they also need to add in time to park and time to travel from their parking space to the classroom. These factors may vary, sometimes widely, by both day and time of day, making them hard to reliably predict. Trying to park as close as possible to a classroom, driving around to multiple parking lots and finding parking that matches the student's particular permit is a regular part of many students' daily life. The unpredictability associated with finding a place to park can be time-consuming and create unnecessary additional stress. This experience also applies to other contexts such as finding parking in other areas (e.g., malls, urban areas), or accessing other types of resource areas with limited availability.

Currently, for some parking areas, open spots are manually counted to provide users with some indication of parking availability. This approach requires an attendant to be physically present in the parking area, is time consuming and subject to error.

Alternatively, cameras, sensors and/or entry gates may be used to track parking availability. A display at the entry to the parking area may then indicate how many spaces are available. Lights installed in the ceiling of each level of the parking area may indicate whether a particular space is available. These approaches require hardware infrastructure, such as gates, sensors, cameras, and/or indicator lights, to be installed at the parking area and power to be supplied for the system to function, making them costly and resource intensive. Further, in some cases the occupancy information may only be available once a prospective parker is on site, making the information less helpful, especially if the parking lot is full.

Crowd-sourcing to report parking availability is another alternative, but it can be unreliable due to its dependence on the accuracy and availability of user reports.

Where third parties are contracted for any of the above approaches, additional costs may apply.

Other resource areas with limited resource availability, such as shared workspaces, recreation areas, etc. can present similar challenges. A more cost-effective, reliable and dynamic approach to indicating the availability of a resource in a resource area is needed.

According to some examples, a metric associated with resource availability for a geofenced resource area is stored. The stored metric is then updated in response to a geofence event associated with the geofenced resource area. The geofence event may, for example, indicate one or more of a resource-consuming entity entering or a resource-consuming entity exiting a geofence associated with the geofenced resource area, an elevation for the device triggering the geofence event (the elevation may allow for determining a resource for that elevation such as resource availability on a particular floor of a parking structure, etc.), information about the user and/or device triggering the geofence event, etc. A geofence event may also be associated with a “dwell” time or intended dwell time of the resource-consuming entity (i.e., an amount of time the resource-consuming entity is occupying the resource or intends to occupy the resource). An indication of resource availability for the geofenced resource area, based at least in part on the metric, is provided in response to a request for resource availability information associated with the geofenced resource area. Examples of metrics may include, but are not limited to one or more of: occupancy (e.g., of a lot and/or all lots), lot visits, adequacy, traffic flow over time (e.g., is there sufficient supply), parking ratios (e.g., supply versus deficit), dwell time (e.g., turnover), payment information, weather information, permit types, the route traveled, speed of the route traveled, origin information, destination information, the number of visits per day (e.g., for a user, all users, a proper subset of users such as disabled, etc.), vacancy, entry and exit locations, etc. Metrics may vary depending at least in part on the particular geofenced resource area or type of geofenced resource area. In some examples, at least some of the metrics are to be made available to resource owners.

For some examples, the resource availability information may be provided to a device or user through an application user interface, which may be a graphical user interface (GUI), of a mobile or web-based application. The resource availability information may be provided in response to a request for availability information, for example. The geofenced resource area may also be administered and managed through the same or a separate user interface.

A geofenced resource area may include any resource area for which a geofence may be implemented and that has limited resources available for use or occupancy. The geofenced resource area includes the area within and including the geofence perimeter. Examples include, but are not limited to, parking areas, recreation areas, event venues, shared workspaces, etc. The associated resources for these areas are parking spaces, charging stations, etc. (for the parking area example) or other types of spaces or resources such as picnic tables, pay stations, etc. depending on the type of resource area. Resource-consuming entities include, for the parking lot example, cars or other vehicles that may occupy the parking spaces. For other examples, resource-consuming entities may include people, families, or other entities that use or occupy the resources.

Using this approach, resource availability information (such as, for example, parking space availability), may be dynamically updated to provide resource-consumers with current information at any given time and from any location (assuming they have connectivity to receive data), while avoiding the high expenses of installing hardware infrastructure or the inherent unreliability of user reporting.

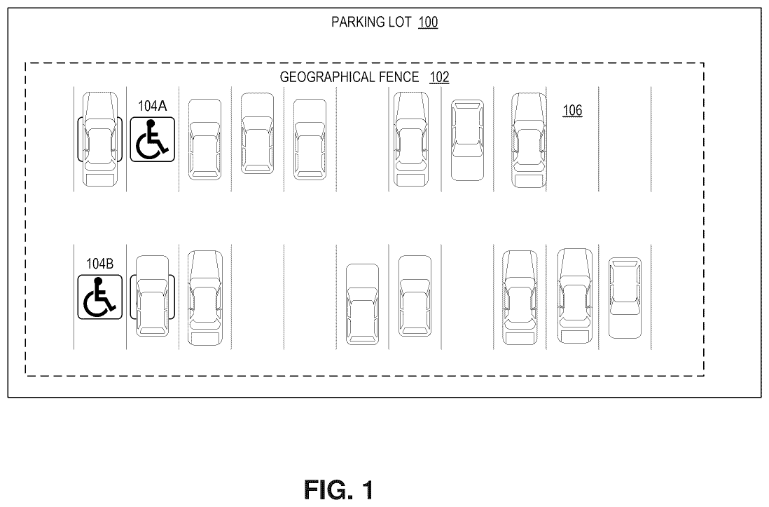

FIG. 1 illustrates an example of a geofenced resource area—in this case, a parking area or lot 100—for which availability may be indicated and managed. In the description herein, the terms “parking area” and “parking lot” are used interchangeably to refer to any area or structure where a vehicle (e.g., a car, truck, motorhome, motorcycle, bicycle, scooter, etc.) can park or otherwise occupy a space designated for the vehicle type. While the parking lot 100 of this example is shown as being rectangular and including a certain number of spaces, other parking lot configurations, including multi-level structures, bike racks, etc. may be used in other examples.

The parking lot 100 includes multiple resources in the form of parking spaces, some of which are available and some of which are occupied as shown. A geofence 102 is associated with the parking lot 100 and has a virtual perimeter that encompasses and/or intersects with location coordinates associated with each of the real-world parking spaces of the of the parking lot 100 for which availability information is to be provided. The geofence 102 may be implemented using global positioning system (GPS) or other geolocation/mapping technology to identify and define the geofence 102 and store the associated information as a geofence. The geofence 102 perimeter may be implemented as a radius around a given point or according to three or more specific geolocation points that define its boundary. For some examples, a geolocation service such as geolocation services provided by Radar Labs, Inc., Google, Apple or others may be used to implement the geofence 102. Alternatively, a mobile device with location services or a mapping component or other component or service with location capabilities may be used. Once implemented, the geofence 102 comprises geolocation information that defines its perimeter and the area it encompasses.

With continuing reference to FIG. 1, an indication of parking space availability at the point in time shown in FIG. 1 may include, for example, a qualitative indicator such as color coding, a phrase indicating relative occupancy level, or a percentage of spaces occupied. Other indicators may include the number of available parking spaces, the types of parking spaces available or any other indicator or combination of indicators. In the example of FIG. 1, the types of parking spaces include handicapped spaces such as spaces 104A and 104B, another type of space 106, and standard spaces. Other parking space types, such as for the space 106, or other types of spaces for other examples may include, without limitation, electric vehicle spaces with charging stations, compact spaces, motorcycle spaces, short-term spaces, spaces designated for certain types of users, bike rack spaces, pay stations, etc. The parking space type may also or alternatively indicate a type of permit or other credential required to park either in the lot 100 or in a particular space.

As vehicles enter and park or exit after parking, parking space availability for the parking lot 100 changes. To keep the indication of parking space availability information current, if a vehicle enters or exits the geofence 102 as determined by at least the vehicle's location (in some examples, a speed associated with the vehicle is also used in the determination of an entry and/or exit), or for some examples, if a vehicle stays within the geofence 102 or intends to stay within the geofence 102 for a period of time (referred to herein as its dwell time), a geofence event is triggered and a metric, such as the number of available parking spaces for the parking lot 100, is updated accordingly. The terminology entering, exiting or dwelling within a geofence is used herein to refer to entering, exiting or dwelling within a physical area with geolocation coordinates corresponding to the associated geofence.

For some examples, to trigger a geofence event when entering or exiting the geofence 102, each vehicle that uses the parking lot 100, or a person with or within the vehicle, uses a parking user application and associated location or mapping services. The vehicle or person is associated with a user account through the parking user application, which is downloaded to the vehicle or to a mobile device that travels with the vehicle. For examples where the parking lot 100 requires a permit, payment or other credential, a prospective user of the parking lot may be required to download the parking user application to purchase or otherwise qualify for the permit, credential or option to park in the lot 100. The prospective user may also be required to enable location services in connection with the parking user application to trigger geofence events when entering or exiting the parking lot 100 with their vehicle or indicating an anticipated dwell time within the parking lot 100. A dwell time may correspond, for example, to an amount of time for which the user has purchased parking. Note that speed may be used as an additional data signal for the determination of vehicle entry or exit. For example, if a user enters a parking lot at a low speed (e.g., slower than a typical car in a parking lot) and leaves the parking lot after a short period of time at the same or similar speed, the user is likely not leaving in their vehicle, but returned to the vehicle for some reason (such as to exchange books, etc.).

The parking user application, in communication with a mapping component or service, uses location data such as global positioning system (GPS) information associated with the user or the user's vehicle to determine if a geofence event is triggered. Location data may be provided by one or more mapping components, application programming interfaces (APIs) or services such as Google Maps, geofencing and/or location platforms from Radar Labs, Inc., Maps by Apple, Inc. or another mapping or location services platform. Mapping services may also be used to implement the geofence associated with the parking lot as described above, and/or for navigation purposes to provide directions to the parking lot, for example. As the geolocation coordinates associated with the user's vehicle through the parking user application intersect the geolocation coordinates corresponding to the geofence 102, a geofence event is triggered if the vehicle is determined to be entering or exiting the geofence. For some examples, a vehicle's location is only tracked through the parking user application upon entering and within the geofence 102. Once the vehicle exits the geofence 102, its location is no longer tracked through the parking user application in some examples. Within the geofence 102, a vehicle's dwell time may be determined, which may, for some examples, also trigger a geofence event that may cause data associated with the parking lot 100 to be updated.

Where the availability of particular parking space types is tracked, the parking user application may also provide an option for a user to report the type of parking space in which they park. For some examples, particularly where various types of parking spaces are grouped together, the parking user application may determine the type of parking space a user has occupied using a mapping component or service to determine their location within the parking lot and infer a space type.

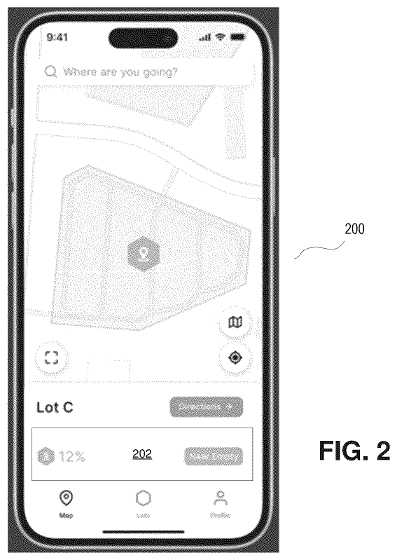

FIG. 2 illustrates an example user interface screen 200 for the parking user application that provides the user with current parking space availability information. The example user interface screen 200 shows an indication of parking space availability 202 for a parking Lot C in the form of a percentage of parking spaces occupied and the phrase “Near Empty.” In some examples, one or more of the percentage of spaces occupied and the “Near Empty” indicators are color coded for an easy visual reference to indicate a relative level of parking space availability. The user interface screen 200 also provides the option for directions to Lot C and a general navigation interface as shown. Lot C of this example is associated with a corresponding geofence as described in reference to lot 100 of FIG. 1.

Referring back to FIG. 1, the parking lot 100 may be one of multiple parking lots in a particular area. For example, the parking lot 100 may be one of several parking lots on or near a college campus, school, public transportation station, etc., each of which, like parking lot 100, is associated with a corresponding geofence.

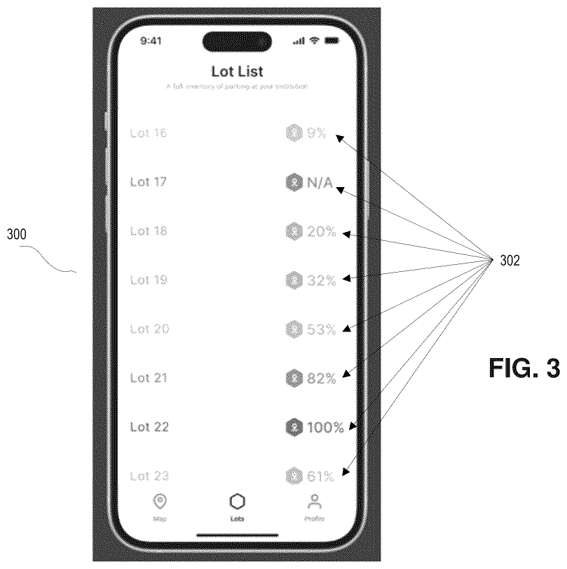

FIG. 3 illustrates an example user interface screen 300 for the parking user application showing indications of parking space availability 302 for each of several Lots 16-23 on a campus or other area according to some examples. Each of Lots 16-23 is associated with a corresponding geofence as described above. The indications of parking space availability 302 for each of lots 16 and 18-23 show the percentage of spaces occupied and, in some examples, are also color coded, similar to a heatmap, to indicate their relative occupancy levels. The “N/A” indication associated with Lot 17 may mean, for example, that Lot 17 is closed, is not available for parking with the permit associated with the particular user or is otherwise unavailable. Providing parking availability information for each of multiple lots in a given area may enable a user to quickly determine their preferred option for parking that is both close to their destination and also likely to have an available parking space at the time they arrive.

In addition to indicating parking availability to a user through the parking user application, for example, it may be desirable for a parking lot administrator or other personnel to have insight into and management capabilities related to use of the parking lot. Similar capabilities may be helpful for other geofenced resource areas.

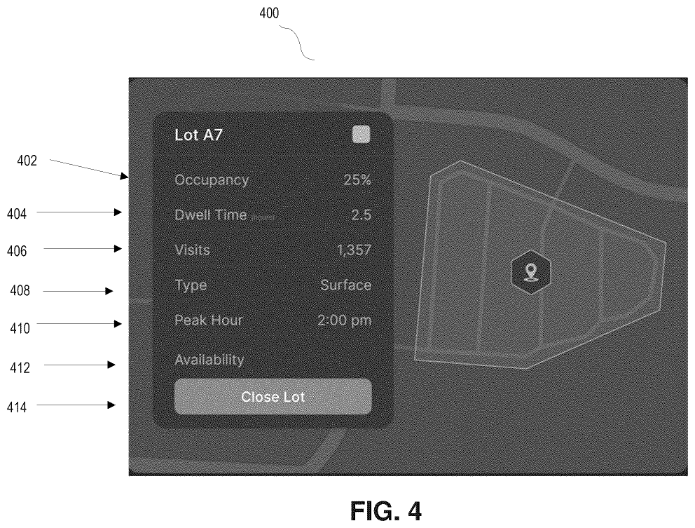

For some examples, various administrative tools are provided either through an administrator interface to the parking user application or through a separate administrator mobile or web-based application. FIG. 4 illustrates an administrator interface screen 400 of some examples. The screen 400 may include various information and data associated with the subject parking lot, Lot A7, including the current occupancy level 402, an average dwell time 404 (i.e., the average time a vehicle is parked in the lot), a total number of individual visits to the lot in a given timeframe 406, the type of lot 408, the time when the lot is the busiest 410, and whether or not the lot is available for parking 412. Other metrics such as types of available spots, cost to park, etc. may also be provided. These metrics provide insights to parking lot administrators to help identify and manage efficient parking lot usage including, for example, analyzing parking demand, monitoring traffic, determining whether additional parking is needed, identifying unused or low-use areas, and providing traffic control for busy periods.

The administrator interface screen 400 also includes a link 414 to manage availability of the lot. It may be desirable, for example, to close a lot during certain hours for construction or other maintenance, for a special event, to direct prospective parkers to other lots or for another reason. If an administrator would like to close Lot A7 so it is no longer indicated as being available to some or all users of the parking user application, the availability status of Lot A7 can be changed or updated using the link 414. Once Lot A7 has been closed, the text associated with the link 414 may change to “Open Lot” (or other legend) and the link can be used to change the availability status from “Closed” to “Open” or another status. Status indicators other than “Open” or “Closed”, such as “Special Event” or other special indicator may be used for various examples.

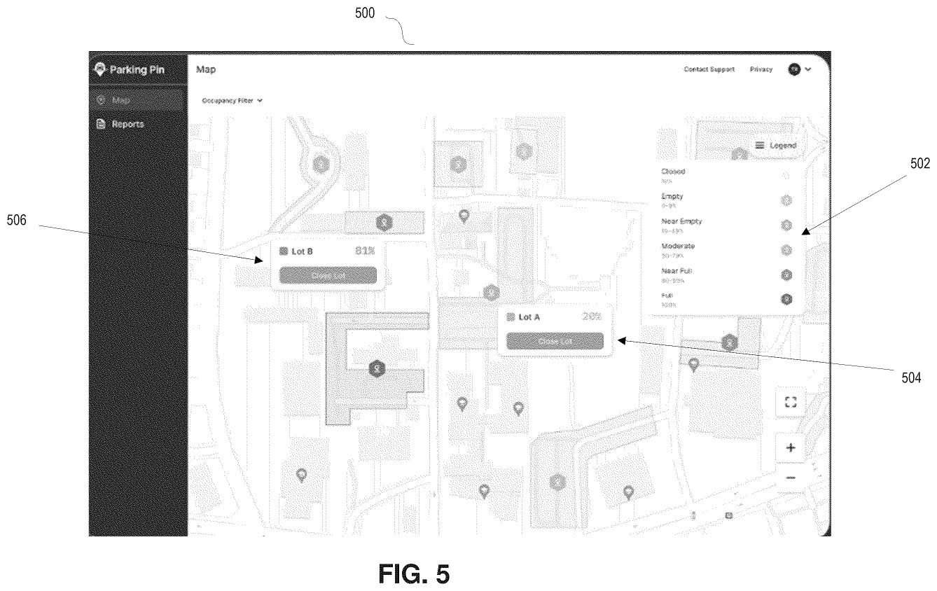

FIG. 5 illustrates another example administrator interface screen 500 showing an availability and/or occupancy status for each of several parking lots in close proximity to each other, such as on a campus or other institution according to some examples. Each of the parking lots represented on the screen of FIG. 5 is associated with a corresponding geofence similar to the parking lot 100 of FIG. 1. In the illustrated screen 500, an availability/occupancy status of each lot is indicated in this example by a shape (which is color coded in some examples) superimposed on the representation of the lot according to the legend 502. As shown in the legend 502, each indication of availability (e.g., “Empty”, “Near Empty”, etc.) is associated with upper and lower thresholds of an occupancy percentage indication in this example. In other words, as the number of spaces occupied metric or number of spaces available metric changes, the indication of availability may change if the metric causes the occupancy percentage indication to cross a threshold associated with a different textual indication of availability for these examples.

Continuing with these examples, if an administrator would like to see further details for a specific lot or would like to change a status of one or more lots, they can click on or otherwise select the representation of the lot on the screen 500. Clicking on the representation of a particular lot brings up a screen associated with that lot that is similar to the screen ‘D00 of FIG. 4. Alternatively, a window including a link, such as the windows 504 and 506 may pop up to enable the administrator to efficiently change a status of a particular lot. Other approaches to providing similar capabilities are within the scope of other examples.

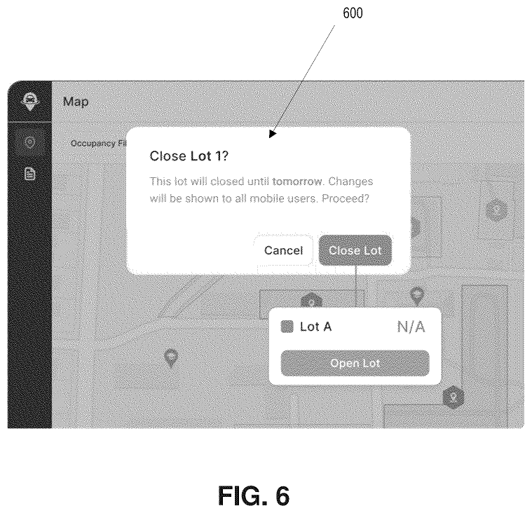

FIG. 6 illustrates a dialog window 600 of some examples that may be displayed to confirm that the administrator would like to proceed with a requested lot closure. The additional step of confirming the closure can help to reduce the likelihood that a lot is closed in error.

One or more of the screens described herein may comprise or include an interactive map interface that enables the user or administrator to interact with the location-based features represented on the screen or interface.

Other administrator tools, such as a capability to enter comments related to one or more parking areas, report generation capabilities, an enforcement interface, or other features may also or alternatively be provided for some examples.

While example screens are shown and described herein, other screen views may be used for other examples such as where a user or administrator has indicated a preference for certain views, capabilities, notifications, or ways to interact with a map, for example,

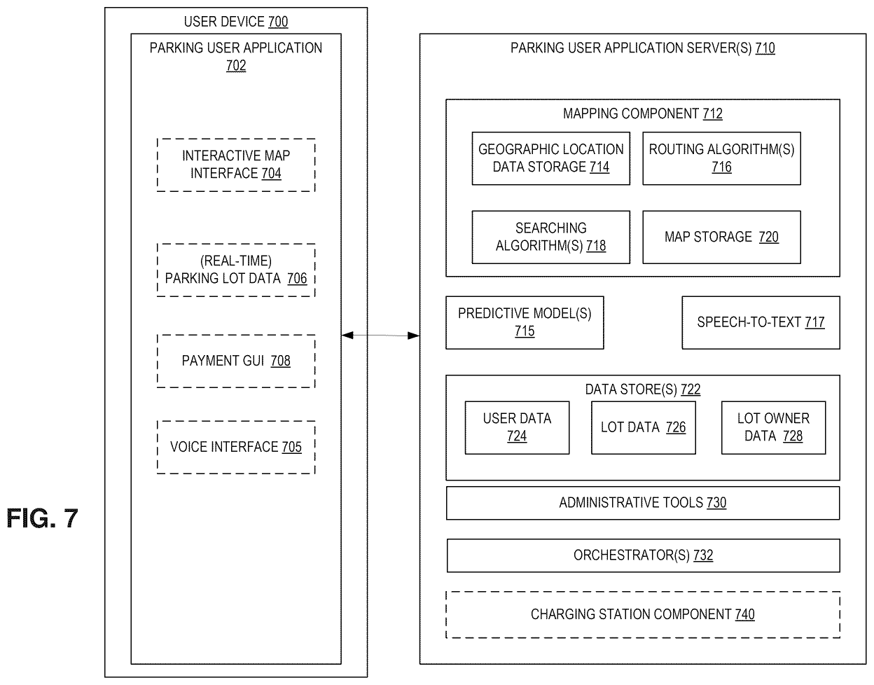

FIG. 7 illustrates examples of a system for geofenced resource availability indication and management to provide some or all of the features described herein. The system of FIG. 7 comprises a parking user application 702 that may be downloaded to a user's device (e.g., a phone, vehicle, or other mobile device such as a smartwatch) and may also be accessible via a web interface. In some examples, the parking user application 702 runs as a background process, at times, to allow the parking user application 702 to perform one or more actions without user input. In some examples, the parking user application 702 runs as a foreground process, at times, to allow the parking user application 702 to perform one or more actions according to user input.

The parking user application 702 includes one or more of an interactive map interface 704 (e.g., a map showing directions to one or more lots, a map showing a particular lot, a map with one or more lots overlaid, etc.), a parking lot data interface 706 (e.g., to display real-time or near real-time parking lot data such as the number of available parking spots, parking lot hours, parking lot availability, etc.), a voice interface 705 (e.g., to receive voice prompts), and/or a payment interface 708 to enable a user to pay for a permit or use of a parking lot, for example, including for special events. The payment interface 708 of some examples provides a connection to a payment service, which may be provided by a third party. Example payment services include Stripe by Stripe, Inc., Square by Block, Inc., and others from their respective providers. Note that the various interfaces may not all be displayed at the same time. Other interfaces and elements, such as an interface or component to indicate preferences, an interface or component to report events or observations and/or an interface to receive notifications, for example, may also be included for various examples.

Examples of notifications that may be received include one or more of occupancy of lots frequented by a user, any notifications related to preferences set by a user, notifications indicating certain changes in lot occupancy, etc. For some examples, if the user's vehicle is an electric or hybrid vehicle that is parked at a charging station in a geofenced lot, the parking user application 702 may notify the user when their vehicle is charged or almost charged. This notification may be based on an indication from a charging station in the parking space or a dwell time of the vehicle that corresponds to an estimated charging time, for example.

The parking user application 702 communicates with one or more parking user application server(s) 710. The parking user application server(s) 710 may be associated with a cloud provider, such as Google, Amazon, Microsoft, etc. or other network or may be standalone servers. The parking user application server(s) 710 include a mapping component 712 comprising one or more of geographic location data storage 714, routing algorithms 716 (for initial routing and/or re-routing (e.g., based on updated availability)), searching algorithms 718 and map storage 720. The various elements of the mapping component 712 may be used to define and establish a geofence, identify geofence events, find geofenced resource areas, and navigate to destinations, for example. In some examples, the mapping component 712 is software stored in the user's device.

In addition to routing and searching, the algorithms 716 and 718, or another set of algorithms (not shown), determine whether to trigger a geofence event if a user of the parking user application 702 enters or exits a particular geofence. For example, once a user has parked, they typically walk, take a wheelchair, bike, skate, or otherwise travel from their vehicle in the parking lot to their intended destination. If the user has their parking user application 702 open or running during this time, it is desirable to avoid triggering a geofence event based on this action. The algorithms of the mapping component 712 may use data, such as a rate of change in a location of the user or acceleration data or any other indication of speed, for example, and apply confidence levels to distinguish between events that indicate a change in parking space availability and those that do not. In this manner, triggering a geofence event erroneously in this situation can more reliably be avoided to reduce the likelihood of a negative impact on the accuracy of the resource availability data.

With continuing reference to FIG. 7, the parking user application server(s) 710 also include one or more data stores 722. The data store(s) 722 store one or more of user data 724, lot data 726 and lot owner data 728. For examples where the parking user application server(s) 710 are provided by a cloud provider (e.g., Google), the data store(s) 722 may also be provided or hosted by the cloud provider (e.g., Google's Firebase cloud-hosted database for examples where the cloud provider is Google). For some examples, some or all of the user data 724, lot data 726 and/or lot owner data 728 may be encrypted at rest or otherwise stored in a way that is intended to prevent unauthorized access.

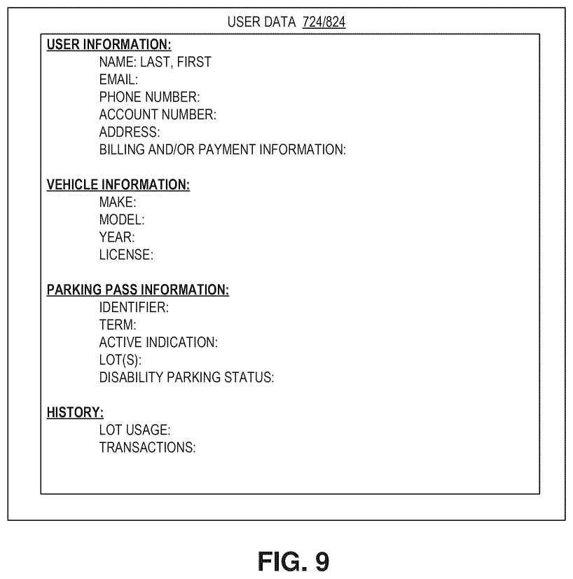

User data 724 may include data to connect a parking user application 702 account to a particular user and/or authenticate a user of the parking user application 702. This user data 724 may comprise one or more of an email address, a physical address, a telephone number, an account username or user ID, password, a parking permit type and status, personal information associated with a user such as a preferred parking lot or a parking schedule, for example, and other data associated with the user that is used to provide parking availability and/or management services. For some examples, only an email address and possibly associated user credentials are stored, while for other examples, other types of information, such as location-based events may be stored. One or more elements of the user data 724 may be stored as a random string or otherwise encrypted to protect the data from unauthorized access, for example. For some examples, the user data may include any settings or preferences set by the user through the parking user application 702. Preferences may include indications of one or more of preferred parking lots, types of spaces, times of day to park, user interface preferences such as how lot information may be viewed or represented, for example, map interaction preferences, location sharing or other permissions, notification preferences, font size, navigation features, etc. User data 724 may also include a user permit type, one or more vehicles associated with the permit, vehicle type information, user application or user, payment information, transaction history, parking lot usage history, a user profile, accessibility information, etc. Other user-specific data related to the use, functionality and/or features of the parking user application may also be stored in user data 724. FIG. 9 illustrates examples of user data 724 (or 824).

Lot data 726 includes data for each lot that is managed or for which availability is indicated through the parking user application or an administrator application or interface. The lot data 726 includes one or more of geofence or other relevant location data, geofence event information, institution name, metrics indicating parking space availability or lot occupancy, indicators of users occupying spaces in the lot, indicators of relative parking space availability or occupancy, lot capacity, types of spaces in the lot, geofence coordinates for a geofence associated with the lot, lot status, lot location, lot usage data, peak and off-peak occupancy times, any permits required for the lot, rules and regulations, user agreements, and/or any other contextual or other data associated with the lots that may be used to manage the lots or indicate lot characteristics, usage of the lot(s) or availability of parking. The lot data 726 may be used by one or more of the parking user application 702, or an administrator application or interface to provide relevant information or capabilities. The lot data 726 may also store historical data for the one or more metrics. Timestamps may be associated with data as it is stored so that the historical data can be used for reporting and analysis purposes, for example.

For some examples, lot data 726 may include pricing for parking in the lot, which may either be fixed or dynamic. Dynamic pricing may vary by one or more of the day of the week, time of day and/or demand or forecasted demand, for example, and may be managed either automatically or by an administrator.

Lot owner data 728 may include data relevant to or used by an administrator to manage or oversee the lots that are covered by the parking user application or an administrator application or interface. For some examples, lot owner data 728 may include many elements of data that are similar to the user data described above including data relevant to an administrator account, including login information, preferences and/or settings. The lot owner data 728 of some examples may include reports on the lots and/or reporting options, which may be custom to the administrator, comments, preferences for one or more specific or customized analytics or other dashboard to view lot operational or other information, including, for example, traffic, notifications of any upcoming events, trends, revenue, etc.

For some examples the parking user application server(s) 710 includes administrative tools 730 to enable an administrator of a parking area to manage and oversee operation of the parking area. The administrative tools 730 provide one or more administrative capabilities such as enabling an administrator to view and/or change a status of a parking lot, manage parking permits, view and/or manage data related to parking lot(s), prepare reports, use forecasting tools, provide enforcement capabilities (e.g., in connection with a decal application), respond to user reports regarding one or more parking lots, detect anomalies (e.g., in user status, lot status, etc.), etc. Reporting capabilities may include options to generate reports per lot by timeframe (e.g., hour by hour, for a particular month, etc.) indicating usage and other characteristics of the lot.

The administrative tools 730 may be accessible via an administrator interface to the parking user application 702, through a separate parking administrator application or via a web interface, for example.

Orchestrator(s) 732 assist with data transformations, server management, authentications, and automation of workflows to coordinate and manage communications between applications including the parking user application 702 and various components and services of the parking user application server(s) 710, for example.

For some examples, parking user application server(s) 710 may include additional data analysis and forecasting tools, which may be part of the administrative tools 730 or provided as separate administrator-accessible and/or user-accessible tools. The additional data analysis and forecasting tools, which may include machine learning or other artificial intelligence (AI) capabilities (such as predictive models 715) and/or a search engine, provide one or more of future parking usage insights, historical usage trends, routing for autonomous vehicles from one point to another and/or other data analysis and forecasting.

For instance, for some examples, if a user is directed to a first parking lot close to, for example, a first class of the day, but their last class of the day is across campus, the user may be a significant distance from where they parked. The additional data analysis and forecasting tools may enable the parking user application 702 to route the vehicle to a parking lot or other location closer to the user.

In some examples, the parking user application server(s) 710 include a charging station component 740. The charging station component 740 interacts with one or more charging station providers and/or services to allow a user to charge an electric vehicle. The charging station component 740 may also be used to update the interactive map interface 704 with charging station availability, pricing, etc. In some examples, the charging station component 740 is an application on the user's device.

In some examples, the voice interface 705 allows a user to prompt for data, a task, etc. For example, the voice interface 705 may allow a user to provide a voice prompt to a speech-to-text component 717 (e.g., an automated speech recognition (ASR) model, punctuation model, etc.) to convert the voice prompt to text. Text may be input into one or more predictive models 715 (e.g., generative artificial intelligence (GenAI) models) as a prompt. The output of the predictive model(s) 715 may be used to interact with other components such as the mapping component 712, administrative tools 730, etc. In some examples, one or more of the predictive model(s) 715 and/or speech-to-text component 717 are on the user device and may be a part of the parking user application 702.

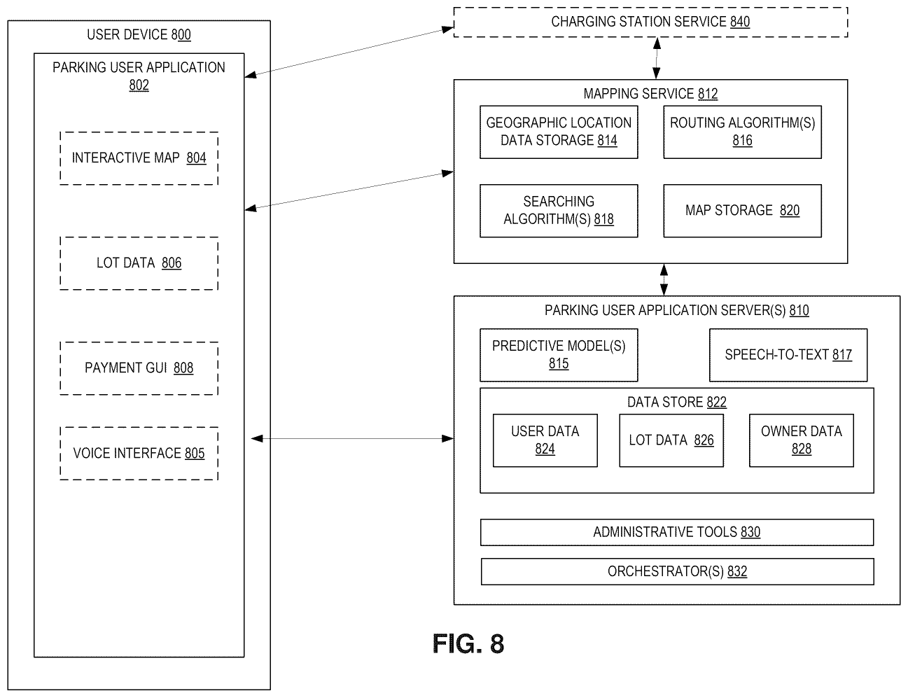

FIG. 8 illustrates a system of another example using a third-party mapping service 812 (hosted by one or more servers) instead of the mapping component 712 of FIG. 8 to provide similar capabilities as the mapping component 712. Other elements of FIG. 8 provide similar capabilities to similarly named elements of FIG. 7 as described above. The orchestrator(s) 832 of FIG. 8 additionally orchestrate communications between the mapping service 812 and other elements illustrated in FIG. 8. Note that the numbers of FIG. 8 mirror those of FIG. 7 (with the exception of there being a separate mapping service 812). In some examples, a charging station service 840 is also provided by and hosted by a third party. As such, the illustrated components have the same or similar functionality.

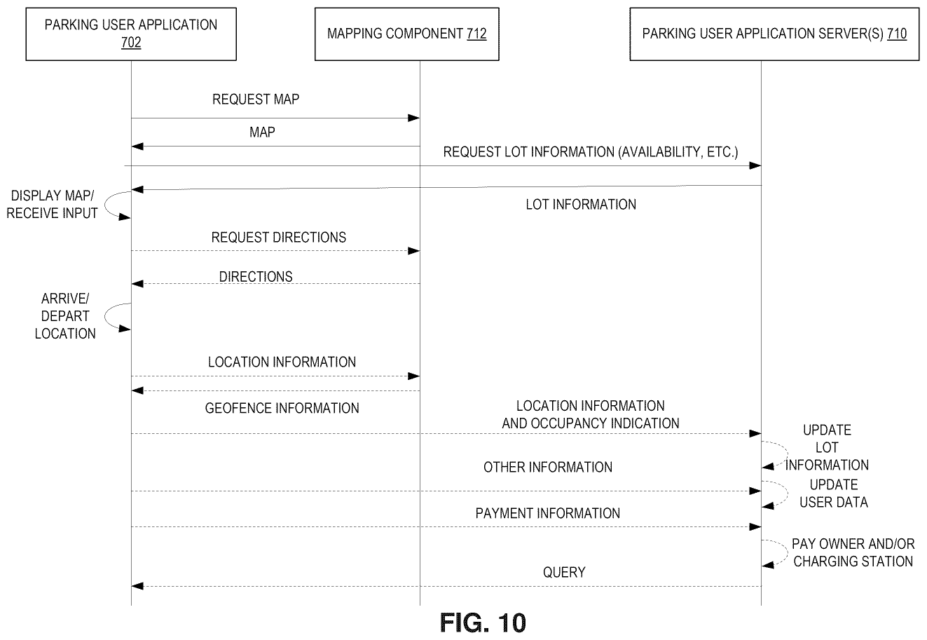

FIG. 10 illustrates examples of a flow for indicating availability and managing a geofenced resource area where the geofenced resource area is a parking lot as discussed above. While the flow refers to elements of FIG. 7, similar elements of FIG. 8 may operate in a similar manner.

As shown, a request for a map of, or a map to, a geofenced parking area or campus including geofenced parking areas is received by the mapping component 712 from via the parking user application 702. In response, the mapping component 712 provides the requested map, which may be displayed to a user via a user interface. In some examples, the map is to be automatically displayed upon opening the parking user application 702. In some examples, the request for the map is a verbal prompt from a user that is converted to text to make the request.

A request for parking lot information (e.g., availability or other information) is received by the parking user application server(s) 710 from the parking user application 702, which may be in response to a request via a user interface of the parking user application 702. In response to the request, the parking user application server(s) 710 provide(s) the requested information to the parking user application 702, which may be displayed via a user interface to the user. Note that lot information may include one or more of information about a plurality of lots (e.g., availability, pricing, etc.), information about a particular type of parking spot (e.g., electric charging capable, disabled, etc.), etc.

Optionally, a request for directions to a parking lot identified as part of the lot information is received from or via the parking user application 702. The request for directions is sent to the mapping component 712, which provides the requested directions back to the parking user application 702. The parking user application 702 may then display or otherwise convey the directions to a user.

When a device running the parking user application 702 arrives at, or departs from, a geofenced parking area location, possibly guided by directions provided by the mapping component 712, its location information is provided to the mapping component 712. Geofence information may be provided back to the parking user application 702 indicating whether a geofence event has been triggered. Location information may also be provided from the parking user application 702 to the mapping component 712 as the user or device changes location within the geofenced parking area or leaves the parking area. For some examples, the parking user application 702 and associated mapping component 712 do not track a device's or user's location outside of a parking lot geofence for the purposes of determining parking availability although the device or user's location may be used for navigation.

If a geofence event is triggered, either based on a user or device entering or exiting a parking lot with the associated vehicle and/or on a dwell time in the parking lot (either reported by the user or determined automatically), associated geofence event data and an indicator of a change in occupancy data is sent to the parking user application server(s) 710 and data or information associated with the respective lot is updated. In some examples, the geofence information is provided to the parking user application server(s) 710.

For some examples, if a user's device dies or is otherwise offline as the user enters or exits a geofenced parking lot an anomaly may be flagged. This may happen, for example, if the user is not on an occupancy list indicating which users are parked in the lot. If the device comes back online, the parking user application 702 may update the lot information or otherwise address the anomaly.

In some examples, if a user remains on an occupancy list for an extended period of time (e.g., past a configurable threshold) an anomaly may be flagged.

For some examples, if lot information changes while a user (or the associated device) is enroute to a lot, the parking user application server(s) 710 may provide updated information to the parking user application 702, which may be displayed to a user via a push or other type of notification. In this example, if the lot is either full or almost full, the parking user application 702 may display information related to other nearby lots, re-route the user to another lot or otherwise provide additional information or options.

While examples discussed above refer to indicating availability of and managing one or more parking lots (also referred to as parking areas), it will be appreciated that similar elements may be used to indicate availability of and manage a different geofenced resource area. For example, for indicating the availability of and managing a shared workspace, the parking user application 702 and parking user application servers 710 are replaced with a shared workspace application and shared workspace application servers, etc.

In some examples, the parking user application 702 sends other information to the parking user application server(s) 710. For example, user information to be updated, an indication of a crash (such that the parking user application server(s) 710 can alert emergency personnel and/or vehicle services, etc.

In some examples, the parking user application 702 sends payment information to the parking user application server(s) 710 to pay a lot owner and/or charging station owner.

In some examples, the parking user application server(s) 710 send a query to a parking user application 702. For example, a query may be sent after a period of time has expired inquiring if the user is still parked in a lot. For example, a query may be sent after a period of time has expired inquiring if the user is okay (e.g., if a crash has been detected by the parking user application 702 based on sensor data such as an accelerometer of the user device).

In some examples, a user may use the parking user application 702 to send a distress signal to the parking user application server(s) 710 which may cause administrative tools 730 to call for help (e.g., police, fire, medical, etc.).

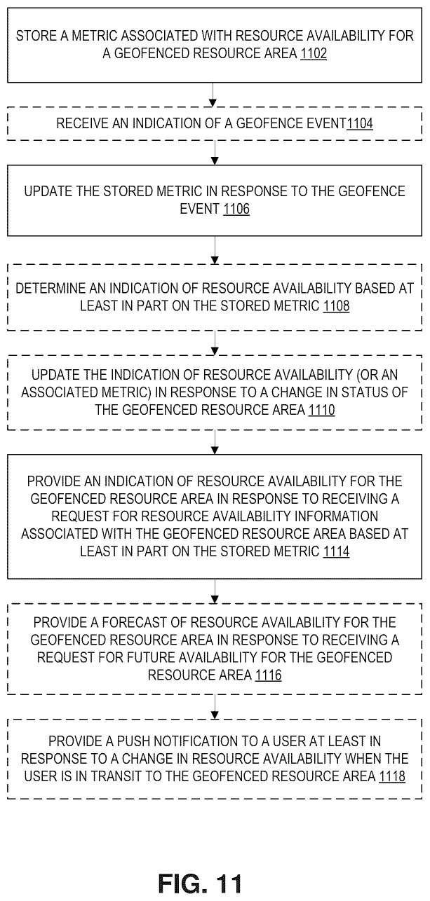

FIG. 11 is a flow diagram illustrating operations of a method for indicating availability of and managing a geofenced resource area according to some examples. Some or all of the operations (or other processes described herein, or variations, and/or combinations thereof) are performed under the control of one or more computing devices configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations are performed by the user application of the other figures.

The operations include, at block 1102, storing a metric associated with a resource availability for a geofenced resource area. If the geofenced resource area is a parking lot, for example, the metric may be a number of available parking spaces, a number of occupied parking spaces or another metric.

At block 1104, an indication of a geofence event is received for some examples. The indication of the geofence may include an indication of a type of geofence event. For some examples, the geofence event is generated from an application running on a device. The device, for example, may be a mobile device with location services.

The operations further include, at block 1106, updating the stored metric in response to the geofence event. For examples for which the geofenced resource area is a parking area or lot, a geofence event may include a vehicle entering or exiting a geofence associated with the parking lot, an indication received from a user of their expected dwell time in the parking lot, or another location-based event that may result in a change in the available parking in the parking lot. Where the metric is a number of available parking spaces for some examples, the metric may be updated to increment the number of available parking spaces when a vehicle leaves the parking lot or decrement the number of available parking spaces when a vehicle enters the parking lot.

At block 1108, an indication of resource availability may be determined based at least in part on the stored metric. For example, if the stored metric indicates a number of available (or alternatively, occupied) parking spaces, and the indication of resource availability is a percentage of occupancy, the stored metric may be used along with the overall number of spaces to determine a percentage of occupancy. For other examples, a percentage of occupancy may then be used to determine a qualitative indicator such as a color coding or phrase that indicates relative occupancy based on predetermined thresholds associated with the qualitative indicators. The indication of resource availability may include, for some examples, an indication of a type of available resource(s). For examples related to a parking area, the type may be one or more of a type of permit associated with a parking spot, a type of vehicle associated with the parking spot, a parking spot with a charging station, a handicapped spot, a pay station or a parking area within a group of parking areas, etc.

At block 1110, the indication of resource availability (or an associated metric for some examples), may be updated in response to a change in status of the geofenced resource area. For examples for which the geofenced resource area is a parking lot, a change in status may be a change from an “open” status to a “closed” or “special event” status, for example.

The operations further include, at block 1114, providing an indication of resource availability for the geofenced resource area in response to receiving a request for resource availability information associated with the geofenced resource area, where the indication of resource availability is based at least in part on the stored metric. Where the geofenced resource area is a parking lot, the indication of resource availability for the parking area may be one or more of a percentage of spaces occupied (or free), a descriptive term indicating a relative availability of parking (e.g., “Empty”, “Nearly empty”, “Almost Full”, “Full”, etc.), a color or other indicator or relative availability of parking spaces (or occupancy), etc. The indication of resource availability may also include an indication of a type of available resource where the type may be one or more of a type of space, permit required, etc. The request may indicate one or more of a location of a device, a general area in which a resource is sought, a permit type, an event, a resource type, a desired dwell time, a preferred resource area, etc.

For some examples, a forecast of resource availability for the geofenced resource area may be provided in response to receiving a request for future availability for the geofenced resource area at block 1116. The forecast may be based at least in part on one or more of data indicating historical usage of the geofenced resource area, expected or reported dwell times, special events, user-reported data, etc.

A push notification may be provided to a device or user for some examples at block 1118, at least in response to a change in resource availability when the device or user is in transit to the geofenced resource area. The push notification may be an update to an interactive map interface, a pop-up text notification or other type of notification. Push notifications may also be provided in response to other events or information or otherwise.

Other operations may be included in the operations in various examples.

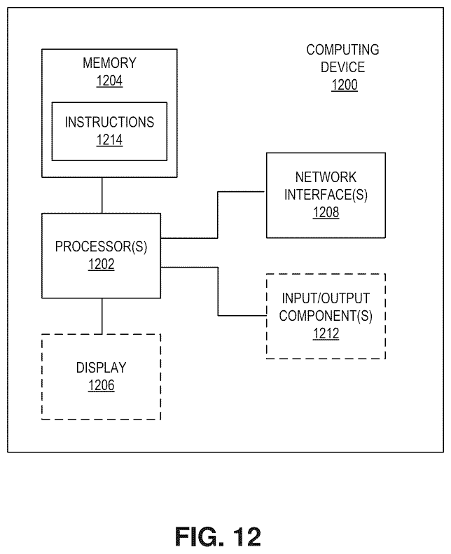

FIG. 12 illustrates a logical arrangement of a set of general components of an example computing device 1200 such as user device 700, user device 800, server(s) 710, server(s) 810, etc. Generally, a computing device 1200 can also be referred to as an electronic device. The techniques shown in the figures and described herein can be implemented using code and data stored and executed on one or more electronic devices (e.g., a client end station and/or server end station). Such electronic devices store and communicate (internally and/or with other electronic devices over a network) code and data using computer-readable media, such as non-transitory computer-readable storage media (e.g., magnetic disks, optical disks, Random Access Memory (RAM), Read Only Memory (ROM), flash memory devices, phase-change memory) and transitory computer-readable communication media (e.g., electrical, optical, acoustical or other form of propagated signals, such as carrier waves, infrared signals, digital signals). In addition, such electronic devices include hardware, such as a set of one or more processors 1202 (e.g., wherein a processor is a microprocessor, controller, microcontroller, central processing unit, digital signal processor, application specific integrated circuit, field programmable gate array, other electronic circuitry, a combination of one or more of the preceding) coupled to one or more other components, e.g., one or more non-transitory machine-readable storage media (e.g., memory 1204) to store code (e.g., instructions 1214) and/or data, and a set of one or more wired or wireless network interfaces 1208 allowing the electronic device to transmit data to and receive data from other computing devices, typically across one or more networks (e.g., Local Area Networks (LANs), the Internet). The coupling of the set of processors and other components is typically through one or more interconnects within the electronic device, (e.g., busses and possibly bridges). Thus, the non-transitory machine-readable storage media (e.g., memory 1204) of a given electronic device typically stores code (e.g., instructions 1214) for execution on the set of one or more processors 1202 of that electronic device. One or more parts of various embodiments may be implemented using different combinations of software, firmware, and/or hardware.

A computing device 1200 can include some type of display element 1206, such as a touch screen or liquid crystal display (LCD), although many devices such as portable media players might convey information via other means, such as through audio speakers, and other types of devices such as server end stations may not have a display element 1206 at all. As discussed, some computing devices used in some embodiments include at least one input and/or output component(s) 1212 able to receive input from a user. This input component can include, for example, a push button, touch pad, touch screen, wheel, joystick, keyboard, mouse, keypad, or any other such device or element whereby a user is able to input a command to the device. In some embodiments, however, such a device might be controlled through a combination of visual and/or audio commands and use a microphone, camera, sensor, etc., such that a user can control the device without having to be in physical contact with the device.

In the preceding description, various examples are described. For purposes of explanation, specific configurations and details are set forth to provide a thorough understanding of the examples. However, it will also be apparent to one skilled in the art that the examples can be practiced without the specific details. Furthermore, well-known features can be omitted or simplified in order not to obscure the example being described.

Bracketed text and blocks with dashed borders (e.g., large dashes, small dashes, dot-dash, and dots) are used herein to illustrate optional aspects that add additional features to some examples. However, such notation should not be taken to mean that these are the only options or optional operations, and/or that blocks with solid borders are not optional in certain examples.

Reference numerals with suffix letters can be used to indicate that there can be one or multiple instances of the referenced entity in various examples, and when there are multiple instances, each does not need to be identical but may instead share some general traits or act in common ways. Further, the particular suffixes used are not meant to imply that a particular amount of the entity exists unless specifically indicated to the contrary. Thus, two entities using the same or different suffix letters might or might not have the same number of instances in various examples.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” is intended to be understood to mean either A, B, or C, or any combination thereof (e.g., A, B, and/or C). Similarly, language such as “at least one or more of A, B, and C” (or “one or more of A, B, and C”) is intended to be understood to mean A, B, or C, or any combination thereof (e.g., A, B, and/or C). As such, disjunctive language is not intended to, nor should it be understood to, imply that a given example requires at least one of A, at least one of B, and at least one of C to each be present.

As used herein, the term “based on” (or similar) is an open-ended term used to describe one or more factors that affect a determination or other action. It is to be understood that this term does not foreclose additional factors that may affect a determination or action. For example, a determination may be solely based on the factor(s) listed or based on the factor(s) and one or more additional factors. Thus, if an action A is “based on” B, it is to be understood that B is one factor that affects action A, but this does not foreclose the action from also being based on one or multiple other factors, such as factor C. However, in some instances, action A may be based entirely on B.

Unless otherwise explicitly stated, articles such as “a” or “an” should generally be interpreted to include one or multiple described items. Accordingly, phrases such as “a device configured to” or “a computing device” are intended to include one or multiple recited devices. Such one or more recited devices can be collectively configured to carry out the stated operations. For example, “a processor configured to carry out operations A, B, and C” can include a first processor configured to carry out operation A working in conjunction with a second processor configured to carry out operations B and C, where the second processor could be part of same computing device as the first processor or part of a separate computing device as the first processor.

Further, the words “may” or “can” are used in a permissive sense (i.e., meaning having the potential to), rather than the mandatory sense (i.e., meaning must). The words “include,” “including,” and “includes” are used to indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for the nouns that they precede, and do not imply any type of ordering (e.g., spatial, temporal, logical, etc.) unless such an ordering is otherwise explicitly indicated. Similarly, the values of such numeric labels are generally not used to indicate a required amount of a particular noun in the claims recited herein, and thus a “fifth” element generally does not imply the existence of four other elements unless those elements are explicitly included in the claim or it is otherwise made abundantly clear that they exist.

The specification and drawings are, accordingly, to be regarded in an illustrative rather than a restrictive sense. It will, however, be evident that various modifications and changes can be made thereunto without departing from the broader scope of the disclosure as set forth in the claims.

What is claimed is:

1. A computer-implemented method comprising:
storing a metric associated with resource availability for a geofenced resource area;
updating the stored metric in response to a geofence event associated with the geofenced resource area, wherein the geofence event indicates one of a resource-consuming entity entering or a resource-consuming entity exiting a geofence associated with the geofenced resource area; and
providing an indication of resource availability for the geofenced resource area in response to receiving a request for resource availability information associated with the geofenced resource area, wherein the indication of resource availability is based at least in part on the stored metric.

2. The computer-implemented method of claim 1, further comprising updating the indication of resource availability for the geofenced resource area in response to a change in status of the geofenced resource area.

3. The computer-implemented method of claim 1, wherein the indication of resource availability for the geofenced resource area comprises an indication of a type of resource, wherein the type of resource is one or more of a parking spot, a charging station, a parking lot, or a pay station.

4. The computer-implemented method of claim 1, wherein the geofence event is to be triggered by an application running on a device.

5. The computer-implemented method of claim 1, further comprising providing a forecast of resource availability for the geofenced resource area in response to receiving a request for future availability for the geofenced resource area, wherein the forecast of resource availability is based at least in part on data indicating historical usage of the geofenced resource area.

6. The computer-implemented method of claim 5, wherein the forecast of resource availability is based at least in part on user-reported data.

7. The computer-implemented method of claim 1, further comprising providing a push notification to a user at least in response to a change in resource availability when the user is in transit to the geofenced resource area.

8. The computer-implemented method of claim 7, wherein the push notification is an update to an interactive map interface.

9. A computer-implemented method comprising:
storing a number of available parking spaces for a first parking area, the first parking area being associated with a first geofence;
updating the stored number of available parking spaces for the first parking area in response to a geofence event associated with the first geofence, wherein the geofence event indicates one of a vehicle entering or a vehicle exiting the first geofence; and
providing an indication of parking space availability for the first parking area in response to receiving a request for parking space availability information, wherein the indication of parking space availability is based at least in part on the stored number of available parking spaces for the first parking area.

10. The computer-implemented method of claim 9, further comprising updating the indication of parking space availability for the first parking area in response to a change in status of the first parking area.

11. The computer-implemented method of claim 9, wherein the indication of parking space availability for the first parking area comprises an indication of a type of parking space for at least one parking space.

12. The computer-implemented method of claim 11, wherein the type comprises one or more of a type of permit associated with the first parking area and a type of vehicle associated with the at least one parking space.

13. The computer-implemented method of claim 9, wherein the first parking area is one of a plurality of parking areas, and wherein the method comprises providing an indication of parking space availability for a second parking area of the plurality of parking areas in response to receiving a request for parking availability information associated with the plurality of parking areas.

14. The computer-implemented method of claim 13, further comprising providing a notification to a user at least in response to a change in parking space availability when the user is in transit to the first parking area.

15. The computer-implemented method of claim 14, wherein the notification is an update to an interactive map interface.

16. The computer-implemented method of claim 9, wherein the request for parking space availability information is an audio request through a voice interface.

17. The computer-implemented method of claim 9, further comprising:
providing a route to the first parking area to be displayed on an interactive map interface.

18. A non-transitory machine-readable medium having instructions stored thereon to cause a machine to perform a method, the method comprising:
storing a number of available parking spaces for a first parking area, the first parking area being associated with a first geofence;
updating the stored number of available parking spaces for the first parking area in response to a geofence event associated with the first geofence, wherein the geofence event indicates one of a vehicle entering or a vehicle exiting the first geofence; and
providing an indication of parking space availability for the first parking area in response to receiving a request for parking space availability information, wherein the indication of parking space availability is based at least in part on the stored number of available parking spaces for the first parking area.

19. The non-transitory machine-readable medium of claim 18, wherein the method further comprises:
providing a notification to a user at least in response to a change in parking space availability when the user is in transit to the first parking area.

20. The non-transitory machine-readable medium of claim 18, wherein the method further comprises:
providing a route to the first parking area to be displayed on an interactive map interface.
